(19) United States
(12) Patent Application Publication
(10) Pub. No.: US 2008/0204228 A1
(43) Pub. Date: Aug. 28, 2008

(54) High-Frequency Monitoring System

(76) Inventors: Reiner Krapf, Reutlingen (DE); Michael Mahler, Leinfelden-Echterdingen (DE)

Correspondence Address: MICHAEL J. STRIKER, 103 EAST NECK ROAD, HUNTINGTON, NY, 11743, US

(21) Appl. No.: 11/994,882

(22) PCT Filed: Oct. 2, 2006
(86) PCT No.: PCT/EP06/66967

§ 371 Date: Jan. 7, 2008

(30) Foreign Application Priority Data
Oct. 6, 2005 (DE) 102005047923.5

(51) Int. Cl. G08B 13/18

(52) U.S. Cl. 340/552

(57) ABSTRACT

The invention relates to a high-frequency monitoring system comprising an emission unit (2) for emitting a high-frequency monitoring beam (16) and a reception unit (4) for receiving the same. According to the invention, said high-frequency monitoring system comprises a beam deflection means (8a-f) which is used to deflect the monitoring beam (16) and is arranged at a distance from the emission unit (2) and the reception unit (4) along at least one monitoring path (18).

### PRIOR ART

It is known, for monitoring or surveillance of routes, areas, or rooms against the penetration of persons, foreign bodies, or body parts, to use infrared detectors, photoelectric barriers, or radar sensors. Depending on the type of monitoring device, one or more monitoring signals are transmitted in one or more directions, and the response is evaluated. In the field of tool technology, it is known from German Patent Disclosure DE 102 61 791 A1 to monitor the near vicinity of a circular saw blade with the aid of a radar sensor and to switch off the saw blade if a user comes into the vicinity of the saw blade. For monitoring large areas or multiple rooms, usually multiple sensors are employed.

### ADVANTAGES OF THE INVENTION

The invention is based on a high-frequency monitoring system having a transmission unit and a receiving unit for respectively transmitting and receiving a high-frequency monitoring beam.

It is proposed that the high-frequency monitoring system have a beam deflecting means for deflecting the monitoring beam, this means being distant, by at least a monitoring distance, from the transmission unit and from the receiving unit. As a result, a plurality of rooms or twisting paths can be monitored with a single transmission unit and in particular with a single receiving unit, without having to do without the advantages of high-frequency monitoring in contrast to infrared monitoring or laser monitoring. For external monitoring, a single sensor for instance suffices, which can monitor the entire building from outside with beam deflecting means—expediently a plurality of them. As a result, a networklike connection of a plurality of sensors to a central evaluation station can be dispensed with. An advantage of the high frequency is that a person entering the area cannot detect a high-frequency monitoring signal except with great effort. In addition, a transmission unit and a receiving unit can be hidden behind other materials and thus kept invisible to unauthorized persons, since high-frequency radiation passes essentially unhindered through many materials.

The transmission unit for transmitting high-frequency radiation is understood to be a transmission unit that transmits radiation in the range from 500 MHz to 200 GHz. The range between 20 GHz and 150 GHz is especially advantageous. For transmitting the monitoring beam, the transmission unit may include an antenna, such as a metal element that transmits the monitoring beam—expediently at a frequency outside the thermal radiation frequency. The frequency can be predetermined by an oscillating circuit. The form of the monitoring beam can be selected freely and may or may not be aimed and can be one-dimensional or like a lobe, for instance. The transmission unit is expediently a radar transmission unit. Such a unit can be embodied in compact and inconspicuous form and is not vulnerable to dirt, environmental factors, and temperature fluctuations. The beam deflecting means advantageously has a high electrical constant, so that the high-frequency radiation is well reflected. A metal beam deflecting means is preferable, but other materials are also conceivable that make good reflection of the high-frequency signal possible, such as beam deflecting means with water or liquids, plastics with a high dielectric constant, or with substances mixed in that have a high dielectric constant.

In a preferred embodiment of the invention, the transmission unit and the receiving unit are secured to a module. A compact system that is easily connected for data communication can be achieved. The transmission unit expediently has a transmitting antenna and the receiving unit has a receiving antenna, and the transmitting antenna and receiving antenna may be located separately, making especially sensitive signal evaluation possible. Alternatively, the transmitting antenna and the receiving antenna are integral, or in other words embodied as a single antenna, as a result of which the system can be kept especially compact.

Advantageously, the high-frequency monitoring system has a further beam deflecting means for guiding a monitoring beam, emitted by the transmission unit, unimpeded, and deflected by the first beam deflecting means, to the receiving unit. The monitoring signal can be guided in a loop and can be guided especially flexibly in the beam guidance. The monitoring beam is unimpeded, without being affected by an object that is to be detected.

A further feature of the high-frequency monitoring system provides a beam reflecting means, for reflecting a monitoring beam, emitted by the transmission unit and deflected by the beam deflecting means, back to the beam deflecting means. As a result, dead-end guidance of the monitoring beam can be achieved especially simply.

Multidimensional room monitoring at a desired point at some distance from the transmission unit can be attained especially simply by means of a beam widening means for widening a monitoring beam, emitted by the transmission unit and deflected by the beam deflecting means, and for emitting it into an ambient area. By embodying the beam widening means such that it is provided for generating an essential two-dimensional monitoring curtain, reliable room monitoring with a relatively slight signal intensity can be attained.

If the beam deflecting means is provided for multiple reflection of the monitoring beam, then once again with a relatively weak signal, reliable multidimensional monitoring can be attained. For that purpose, the beam deflecting means may have a concave shape, optionally interrupted and with or without an inner edge. Expediently, the beam deflecting means is embodied as a metal strip extending at least partway around a room.

A reliably functioning beam deflecting means that is difficult to detect can be attained if the beam deflecting means has a dielectric deflection layer, which is covered by low-dielectric material, preferably located in the monitoring distance. The term “low-dielectric material” is understood to mean material having a dielectric constant of less than 5.

The monitoring beam can be focused by an antenna that emits it. As a rule, a widening of approximately one degree will exist. Good focusing of the monitoring beam can be attained if the beam deflecting means has a focusing means for focusing the monitoring beam. By connecting the focusing means to the beam deflecting means, the number of components used can be kept low, and the calibration effort for the monitoring beam can be kept simple. The beam deflecting means and the focusing means may be identical, for instance by embodying the beam deflecting means in curved fashion. In a further embodiment, the focusing means is embodied as dielectrically active plastic, which forms an electric lens. Still other dielectrically active materials are possible. Such material or such plastic can furthermore be used for widening the monitoring beam.

In a further advantageous feature of the invention, a control unit, which is provided for locating an object located in the monitoring beam. As a result, not only can the entry of the object into the monitoring beam may be monitored, but it can expediently be detected precisely where the object entered the monitoring beam. In addition or as alternative, a control unit, which is advantageously provided for detecting a speed of an object located in the monitoring beam. As a result, an identification of the object can be attained. Detecting the location and/or speed can be determined by emitting radiation pulses or amplitude-modulated radiation and measuring the transit time thereof. It is also possible to determine a distance of the object by means of phase evaluation; here, multifrequency measurement is advantageous, in order to achieve a wide range of phase nonambiguity, along with high measurement precision.

It is especially advantageous to use the high-frequency monitoring system, as described above, in an apparatus with a tool, the tool being in particular movable. A space around the tool that presents a potential risk to a user, for instance, can be monitored, and the tool, such as a saw, can be switched off when a penetration of an object into the monitored space meets certain criteria, such as that the object comes too close to the tool. The monitoring beam is expediently guided around the tool, so that the tool can be monitored from a plurality of sides. Guiding it at least partway around the tool is sufficient.

### DRAWINGS

Further advantages will become apparent from the ensuing description of the drawings. In the drawings, exemplary embodiments of the invention are shown. The drawings, description and claims include numerous characteristics in combination. One skilled in the art will expediently consider the characteristics individually as well and put them together to make useful further combinations.

Shown are:

FIG. 1, a radar monitoring system, with three beam deflecting means located around a building;

FIG. 2, the monitoring system of FIG. 1, with an object in a monitoring distance;

FIG. 3, a high-frequency monitoring system with reflecting means;

FIG. 4, a radar monitoring system with a beam widening means for monitoring a three-dimensional space;

FIG. 5a-5c, a beam widening means and two focusing means;

FIG. 6, a beam deflecting means provided for multiple reflection; and

FIG. 7, a lawn mower with a radar monitoring system.

### DESCRIPTION OF THE EXEMPLARY EMBODIMENTS

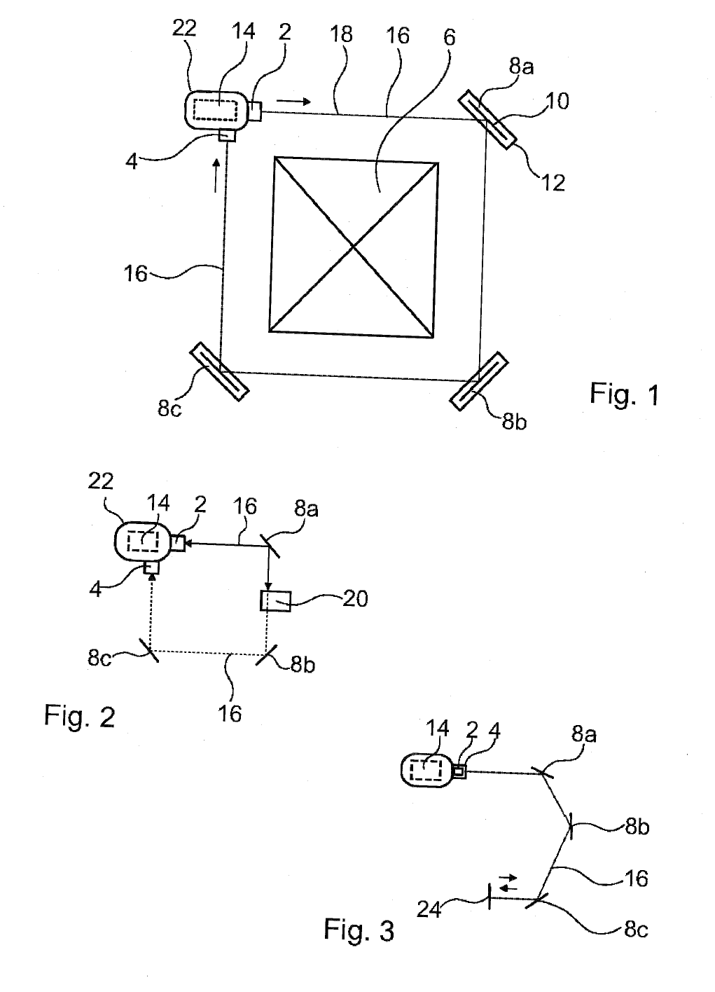

FIG. 1 shows a radar monitoring system with a transmission unit 2 for emitting radar radiation and a receiving unit 4 for receiving the emitted radar radiation. The monitoring system is located adjacent to a building 6, shown schematically, around which three beam deflecting means 8a, 8b, 8c are positioned. Each of the beam deflecting means 8a-8c includes a metal deflection layer 10, which is surrounded by a low-dielectric material 12 in the form of plastic with a dielectric constant Dₖ=4. The material 12 is integrated into further objects, not shown, so that the beam deflecting means 8a-8c are not readily apparent as such from outside. The transmission unit 2 and the receiving unit 4 each have an antenna, not shown, for transmitting and receiving a monitoring beam 16. Both antennas are connected to a control unit 14. For transmitting the monitoring beam 16, the transmitting antenna is triggered by the control unit 14 with a transmission frequency of 122 GHz, and the triggering can be done in frequency-modulated fashion or in the form of signal pulses.

The monitoring beam 16, from the transmission unit 2 to the first beam deflecting means 8a, traverses a first monitoring distance 18 through the air surrounding the building 6 and is conducted from the first beam deflecting means 8a by reflection to the second beam deflecting means 8b. There, it is reflected again by 90°, and again by the third beam deflecting means 8c, and thus after passing through four monitoring distances 18, it reaches the receiving unit 4, by which, in conjunction with the control unit 14, it is evaluated.

In FIG. 2, an object 20 that has penetrated the monitoring beam 16 is shown, by which the monitoring beam 16 is changed in its intensity and phase or blocked, as is recorded by the receiving unit 4 in conjunction with the control unit 14. The control unit 14 thereupon outputs a recording signal, such as an alarm in the form of an acoustical, optical or electrical signal. By locating both the receiving unit 4 and the transmission unit 2 on a common module 22 that accommodates the control unit 14 as well, the entire module 22 can be embodied compactly and with regard to signal transmission can be embodied simply, despite the extensive space that is difficult to monitor.

A small proportion of the monitoring beam 16 is reflected by the object and reaches the transmitting antenna of the transmission unit 2. This signal is also recorded by the control unit 14, and from it, the distance from the transmission unit 2 via the beam deflecting means 8a to the object 20 is calculated and displayed, on a display means for users that is not shown in FIG. 2. By transmitting the monitoring beam 16 for a relatively long time, it is possible in addition to the distance to detect a motion of the object 20 by means of a varying distance. In an alternative feature, the control unit 14 and the transmission unit 2 form a double radar system, by which the speed of the object 20 can be detected directly.

The object 20 can be detected as such by means of an amplitude evaluation of the monitoring signal 16. By additionally evaluating the phase of the monitoring signal 16, a statement can be made as to whether the object is metallic—it generates a phase jump—or for instance a person, who does not generate a phase jump, or generates only a slight phase jump, in the signal.

FIGS. 3, 4, 6 and 7 show alternative monitoring systems; essentially, components that remain the same are identified by the same reference numerals throughout. For characteristics and functions that remain the same, reference may be made to the description of the exemplary embodiment of FIGS. 1 and 2. The description below is limited essentially to the differences from the exemplary embodiment of FIGS. 1 and 2.

In the monitoring system, operating in the microwave range, shown in FIG. 3, the transmission unit 2 and the receiving unit 4 are integrated in one component, and the transmitting antenna and receiving antenna are embodied as a single component. In addition to the beam deflecting means 8a-8c, the monitoring system includes a beam reflecting means 24, which reflects the monitoring beam 16, arriving from the last beam deflecting means 8c, back to the beam deflecting means 8c and thus sends it back to the receiving unit 4 and the transmission unit 2. By means of this arrangement, dead-end beam guidance is achieved.

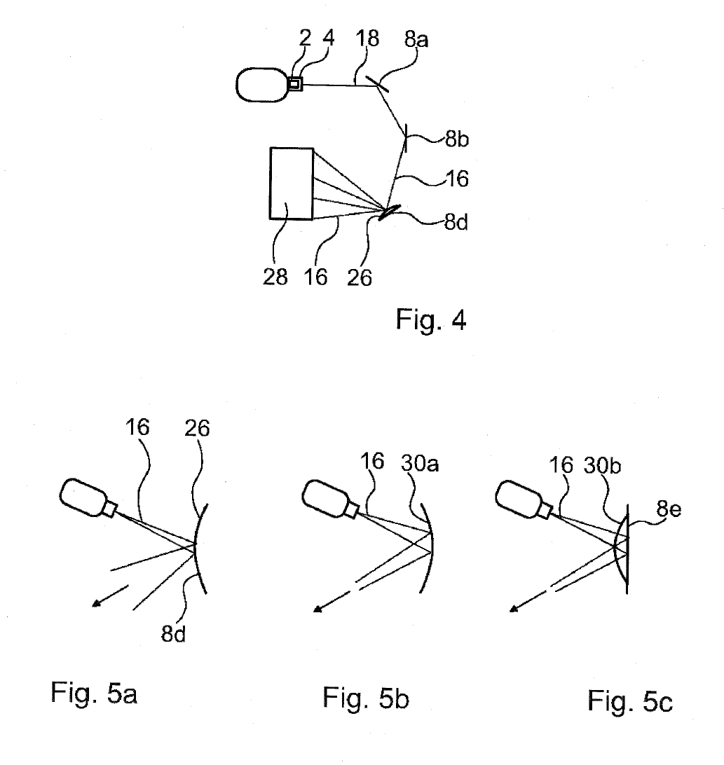

The radar monitoring system shown in FIG. 4 has a beam widening means 26 on a beam deflecting means 8d; the beam widening means widens the monitoring beam 16 arriving from the beam deflecting means 8b, so that this beam is directed into a three-dimensional space 28 that is to be monitored and illuminates it essentially completely. In this way, monitoring of a three-dimensional space 28 at an essentially arbitrarily selectable location is achieved, and the transmission unit 2 can be located at some distance from this space 28. In addition to this space monitoring, barrier monitoring is attained within the monitoring distance 18 between the transmission unit 2 and the beam widening means 26.

The beam widening means 26, which is simultaneously a combination with the beam deflecting means 8d, is shown schematically in FIG. 5a. It is formed of a two-dimensionally convexly curved layer with a high dielectric constant, such as a metal layer, whose curvature is adapted to the size of the space 28 to be monitored. In an alternative feature, the beam widening means 26 may be embodied in the form of a segment of a cylinder, so that the monitoring beam that strikes it is fanned out not three-dimensionally but rather only two-dimensionally. As a result, the monitoring beam 16 can be shaped into a two-dimensional monitoring curtain, which is especially well suited to “locking” entrances.

Analogously to this, in FIG. 5b a focusing means 30a is shown, which is embodied with a concave shape for focusing the monitoring beam 16. Another shape of a focusing means 30b is shown in FIG. 5c. A lens of a dielectrically active plastic is applied to a beam deflecting means 8e embodied as a metal layer. The monitoring beam 16 passes through this lens both before its reflection at the beam deflecting means 8e and after its reflection and is focused somewhat in this beam path.

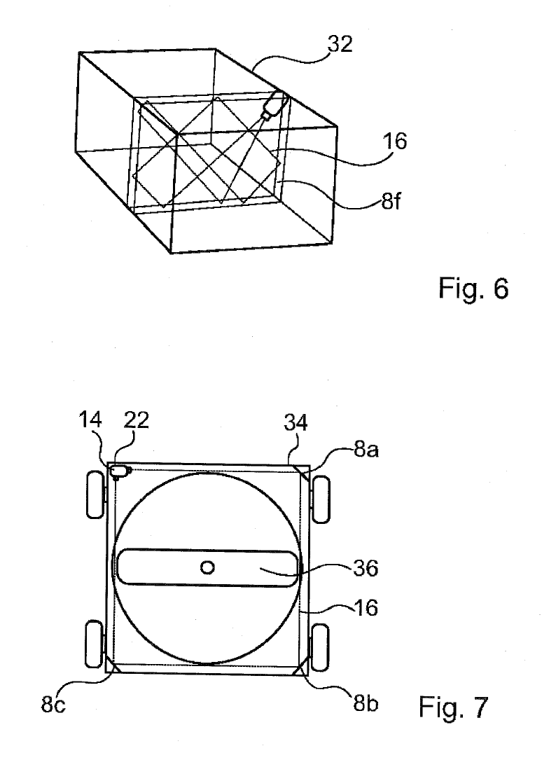

In the monitoring system shown in FIG. 6, a beam deflecting means 8f is embodied in the form of a metal band surrounding a room 32. The widened monitoring beam 16 is reflected multiple times by this metal band and thus forms a two-dimensional curtain that partitions off the two halves of the room from one another. As soon as someone passes through this curtain, the received signal changes, which is recognized by the control unit 14.

A power tool in the form of a lawn mower 34 is shown schematically in FIG. 7. The monitoring beam 16 is guided all the way around a tool 36, in the form of a blade of the lawn mower 34, by three beam deflecting means 8a-8c. If this monitoring beam 16 is interrupted by some object, such as a user's foot, then an immediate stop of the blade is automatically brought about by the control unit 14 that is located in the module 22. Because the monitoring beam 16 moves all the way around the blade, extensive protection of the user is achieved. With the same advantage, instead of the lawn mower 34 and its blade, a circular saw and a circular saw blade, respectively, can be monitored.

1. A high-frequency monitoring system, having a transmission unit (2) for transmitting and a receiving unit (4) for receiving a high-frequency monitoring beam (16), characterized by a beam deflecting means (8a-f) for deflecting the monitoring beam (16), this means being distant, by at least a monitoring distance (18), from the transmission unit (2) and from the receiving unit (4).

2. The high-frequency monitoring system as defined by claim 1, characterized in that the transmission unit (2) and the receiving unit (4) are secured to a module (22).

3. The high-frequency monitoring system as defined by claim 1, characterized by a further beam deflecting means (8b, c) for guiding a monitoring beam (16), transmitted by the transmission unit, unimpeded, and deflected by the first beam deflecting means (8a, b), to the receiving unit (4).

4. The high-frequency monitoring system as defined by claim 1, characterized by a beam reflecting means (24) for reflecting a monitoring beam (16), transmitted by the transmission unit (2) and deflected by the beam deflecting means (8a-c), back to the beam deflecting means (8a-c).

5. The high-frequency monitoring system as defined by claim 1, characterized by a beam widening means (26) for widening a monitoring beam (16), transmitted by the transmission unit (2) and deflected by the beam deflecting means (8a, b), and for transmitting it into an ambient area.

6. The high-frequency monitoring system as defined by claim 5, characterized in that the beam widening means (26) is provided for generating an essential two-dimensional monitoring curtain.

7. The high-frequency monitoring system as defined by claim 1, characterized in that the beam deflecting means (8) is provided for multiple reflection of the monitoring beam (16).

8. The high-frequency monitoring system as defined by claim 1, characterized in that the beam deflecting means (8a-c) has a dielectric deflection layer (10), which is covered by low-dielectric material (12) that has a dielectric constant of less than 5.

9. The high-frequency monitoring system as defined by claim 1, characterized in that the beam deflecting means has a focusing means (30a, b) for focusing the monitoring beam (16).

10. The high-frequency monitoring system as defined by claim 1, characterized by a control unit (14), which is provided for locating an object (20) located in the monitoring beam (16).

11. The high-frequency monitoring system as defined by claim 1, characterized by a control unit (14), which is provided for detecting a speed of an object (20) located in the monitoring beam (16).

12. An apparatus having a tool (36) and a high-frequency monitoring system as defined by claim 1.

13. The apparatus as defined by claim 12, characterized in that the monitoring beam (16) is guided around the tool (36).
